(19) United States
(12) Patent Application Publication
(10) Pub. No.: US 2017/0004812 A1
(43) Pub. Date: Jan. 5, 2017

(54) DETECTING SYSTEM FOR A STRING INSTRUMENT

(71) Applicant: O.M.B. GUITARS LTD, Efrat (IL)

(72) Inventors: SHIMON MIZRAHI, BEIT SHEMESH (IL); BEN ZION THEE, EFRAT (IL)

(21) Appl. No.: 15/265,859

(22) Filed: Sep. 15, 2016

Related U.S. Application Data
(63) Continuation-in-part of application No. PCT/IL2015/050244, filed on Mar. 9, 2015.
(60) Provisional application No. 61/954,937, filed on Mar. 18, 2014.
(60) Provisional application No. 62/381,025, filed on Aug. 30, 2016.

(51) Int. Cl. G10H 1/34; G10H 1/18

(52) U.S. Cl. CPC G10H 1/342; G10H 1/182; G10H 2220/171

(57) ABSTRACT

A detection system is provided for detecting a musical note played on a string instrument having a fretboard provided with a plurality of conductive frets and conductive strings. The system includes at least one conductor coupled to each of the frets; an inverter having a first terminal coupled to the conductor and a second terminal coupled to the conductive string, the inverter being configured to logically invert a signal transmitted therethrough, such that when the conductive string is pressed against one of the frets allowing thereby for a signal to be transmitted therethrough, the signal is sequentially inverted between two logical states at a frequency being dependent on the distance between the inverter and the fret; a frequency detector configured to measure the frequency; and a controller configured for determining the location of the fret along the fretboard in accordance with the frequency, and to thereby detect the musical note.

### FIELD OF INVENTION

The present invention relates to a detecting system for a string instrument, in general, and in particular to a detecting system and a method for detecting and transmitting data representing played strings on a fretboard of a string instrument.

### BACKGROUND

There are known several string instruments provided with a detecting system for detecting the note played. U.S. Pat. No. 4,635,518 discloses an electronic stringed musical instrument having an electrically insulating fingerboard is disclosed. The fingerboard is provided with a number of segmented frets attached across its upper surface at desired points along its length. Each of the frets includes a number of electrically conducting fret segments each of which are electrically insulated from one another. Any number of strings may be provided on the instrument each string is disposed adjacent to and associated with a single fret segment of each of the segmented frets. A top octave generator and octave dividers are utilized to selectively provide a fret segment of one of the frets with an electrical signal of at least one known referencing frequency. The strings are attached to the instrument in a spaced relationship with respect to the fret segments. Displacing a string to contact one of the fret segments completes an electrical circuit having at least one frequency equal to a frequency of the signal provided to that fret segment. Displacing the same string to contact a different fret segment completes a different electrical circuit having at least one different frequency. Simultaneously depressing a plurality of the strings simultaneously completes a number of electrical circuits each capable of producing a number of different frequencies. The amplitude output of the instrument is dependent upon the voltage applied to each of the strings and is controlled by hand operated transducers.

US2012017748 discloses a digital musical instrument including a fretboard and one or more strings extended over the fretboard. The instrument further includes an electric circuit for generating digital signals based on positions associated with contacts of the strings on the fretboard and a transceiver for transmitting the digital signals to a processing device that generates musical notation based on the digital signals.

U.S. Pat. No. 8,454,418 discloses a game controller having one or more strings is described for a computer gaming application. A plurality of frets can be disposed on a fingerboard and underlying the strings. The frets may include electrically conductive zones that can be electrically insulated from each other, and each zone corresponds to a different string. A polyphonic pickup having a plurality of wire-wound coils coupled to corresponding magnetic returns can be included, and can be adapted to detect striking of at least one of the strings by a user of the game controller. Output signals may be sent from the controller to the gaming application indicative of fingering of the game controller and the time at which the strings of the game controller are struck. Multi-mode apparatus are also described. A stringed apparatus may be used as both a game controller and an instrument.

WO2013109657 discloses an electronic stringed instrument practice device can be configured to perform one or more of the following:
detect when finger positions and/or string to fret contact on a finger or fret board forms an appropriate musical note or musical chord, visually indicate appropriate positions on a finger or fret board for forming a musical note or musical chord, and detect when strings have been selected (e.g., strummed). The electronic stringed instrument practice device can emit sound in the form of musical notes and chords. The electronic stringed instrument practice device can include communication modules for communicating with other computing devices, including mobile phones and tablets. The electronic stringed instrument practice device can interact with applications on other computing devices to further assist users in learning how to play a stringed musical instrument.

US2013247744 discloses a stringed instrument is equipped with an electrical conductor electrically connected to the frets mounted in the fretboard of said stringed instrument. Said stringed instrument is also equipped with a power source, light emitting members in electrical contact with the strings of the instrument (in one embodiment light emitting diodes) and electrical conductors electrically connecting together the components of the invention. By means of pressing down anyone of the strings capable of transmitting electric current against anyone of the frets capable of transmitting electric current connected to the electrical circuit comprised of said electrical components, said circuit closes and the light emitting member(s) associated with the string that is pressed down against the fret is lit.

JP2009271484 discloses a sensing means for sensing contact/non-contact is constituted by making a string and a fret in an electricity conductive state, and predetermined light is generated by a performance means interlocking with the sensing means, in a performance device for the string instrument.

### SUMMARY OF INVENTION

There is provided in accordance with an aspect of the invention a fretboard of a string instrument in combination with a detecting system, the fretboard having a plurality of conductive frets disposed at various locations along its length and at least one conductive string extending over and spaced apart from the frets along the length of the fretboard. The detecting system includes a conductor disposed along the length of the fretboard coupled to each of the frets; an inverter having a first terminal coupled to the conductor and a second terminal coupled to the at least one conductive string and being configured to logically invert a signal transmitted therethrough such that when the at least one conductive string is pressed against one of the frets allowing thereby a signal to be transmitted therethrough, the signal is sequentially inverted between two logical states at a frequency dependent on the distance between the inverter and the fret; a frequency detector for measuring the frequency; and a controller for determining the location of the fret along the fretboard in accordance with the frequency.

The fretboard can include a plurality of conductive strings.

The conductor can include two conductors disposed with respect to each one of the plurality of conductive strings such that the average of the distance thereof from each of the plurality of conductive strings is equal for all of the plurality of conductive strings.

The conductive string can be configured to vibrate producing thereby a musical sound. The conductive string can includes a conductive material wound over of a nonconductive core. The conductive string and the plurality of conductive frets can be configured to allow transmitting therethrough a low voltage current such that is not affected by a user's finger. Each one of the plurality of conductive strings can be configured to receive a signal from the inverter.

The inverter can be configured for selecting one of many data-output-lines each of which being coupled to one of the plurality of conductive strings.

The combination can include a demultiplexer having an input configured for receiving an input signal from the inverter and an output configured for selecting one of many data-output-lines each of which being coupled to one of the plurality of conductive strings.

The inverter can be configured to invert an input voltage corresponding to a logical 1 to an output voltage of corresponding to a logical 0.

The combination can further include a controller being configured to detect which one of the plurality of conductive strings is being pressed against one of the plurality of frets.

The the controller and the frequency detector can be integrated in a CPU module.

The combination can further include an electronic component coupled to the inverter and configured to delay the signal thereby increasing the wavelength thereof. The electronic component can be a capacitor.

There is provided in accordance with another aspect of the invention a detection system for detecting a musical note played on a string instrument having a fret board provided with a plurality of conductive frets and at least one conductive string extending along thereof. The detection system includes at least one conductor coupled to each of the frets; an inverter having a first terminal coupled to the conductor and a second terminal coupled to the conductive string, the inverter being configured to logically invert a signal transmitted therethrough, such that when the conductive string is pressed against one of the frets allowing thereby for a signal to be transmitted therethrough, the signal is sequentially inverted between two logical states at a frequency being dependent on the distance between the inverter and the fret; a frequency detector configured to measure the frequency; and a controller configured for determining the location of the fret along the fretboard in accordance with the frequency, and to thereby detect the musical note.

The inverter can be configured to select one of many data-output-lines each of which being configured to be coupled to one conductive strings of a musical instrument having a plurality of conductive strings extending long the fretboard thereof.

The detection can further includes a demultiplexer having an input configured to receive an input signal from the inverter and an output configured for selecting one of many data-output-lines each of which being coupled to one of the plurality of conductive strings.

The first terminal of the inverter can be an input terminal and the second terminal is an output terminal. The inverter can be configured to invert an input voltage corresponding to a logical 1 to an output voltage of corresponding to a logical 0.

The detection system can further include a controller being configured to detect which one of the plurality of conductive strings is being pressed against one of the plurality of frets.

The detection system can further include a capacitor coupled to the inverter and being configured to form a signal resonance in the signal thereby delaying the signal for delaying the signal thereby increasing the wavelength thereof.

The detection system can further include a power source for generating a signal through the conductive string.

The detection system can further include a demultiplexer having an input configured for receiving an input signal from the inverter and an output configured for selecting one of many data-output-lines each of which being coupled to one of the plurality of conductive strings.

The inverter can be configured to select one of many data-output-lines each of which being configured to be coupled to one conductive strings of a musical instrument having a plurality of conductive strings extending long the fretboard thereof. The detection system can further include a demultiplexer having an input configured to receive an input signal from the inverter and an output configured to select one of many data-output-lines each of which being coupled to one of the plurality of conductive strings.

The detection system can further include a controller configured to detect which one of the plurality of conductive strings is being pressed against one of the plurality of frets.

The detection system can further include an electronic component coupled to the inverter configured to delay the signal thereby increasing the wavelength thereof. The electronic component is a capacitor configured to form a signal resonance in the signal thereby delaying the signal.

There is provided in accordance with yet another aspect of the invention a method for detecting a musical note played on a string instrument having a fretboard provided with a plurality of conductive frets each of which being coupled to a conductor, and at least one conductive string extending along the length of the fretboard. The method includes generating an electric signal through the conductive string, that can be transmitted through one of the frets when the conductive string is pressed against the fret; logically inverting the signal by an inverter having a first terminal coupled to the conductor and a second terminal coupled to the conductive string, such that when the conductive string is pressed against one of the frets allowing thereby the signal to be transmitted through the conductor, the signal sequentially inverted between two logical states at a frequency dependent on the distance between the inverter and the fret; detecting the frequency by a frequency detector; calculating the location of the fret along the fretboard in accordance with the frequency; and determining the musical note played on the instrument in accordance with the location.

There is provided in accordance with yet another aspect of the invention a detection system for detecting a musical note played on a string instrument having a fret board provided with a plurality of spaced apart conductive frets each of which being coupled to a conductor, and at least one conductive string extending over the frets. The detection system includes a power source for generating a signal through the conductive string; an inverter having a first terminal coupled to the conductor and a second terminal coupled to the conductive string; a frequency detector configured to measure the frequency; and a controller configured for determining the location of the fret along the fretboard in accordance with the frequency. The inverter being configured to logically invert a signal transmitted therethrough, such that when the conductive string is pressed against one of the frets allowing thereby for the signal to be transmitted therethrough, the signal is sequentially inverted between two logical states at a frequency being dependent on the distance between the inverter and the fret.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a block diagram of a fretboard and detecting system constructed and operative in accordance with an embodiment of the invention;

FIG. 2 is a block diagram illustration of a fretboard and detecting system constructed and operative in accordance with another embodiment of the invention;

FIG. 3 is a graphic representation of an exemplary signal generated by the detecting system of FIG. 1;

FIG. 4 is a graphic representation of an exemplary signal generated by the detecting system of FIG. 2; and

FIG. 5 is a block diagram illustration of an electric circuit for a detecting system constructed and operative in accordance with yet another embodiment of the invention.

### DETAILED DESCRIPTION OF EMBODIMENTS

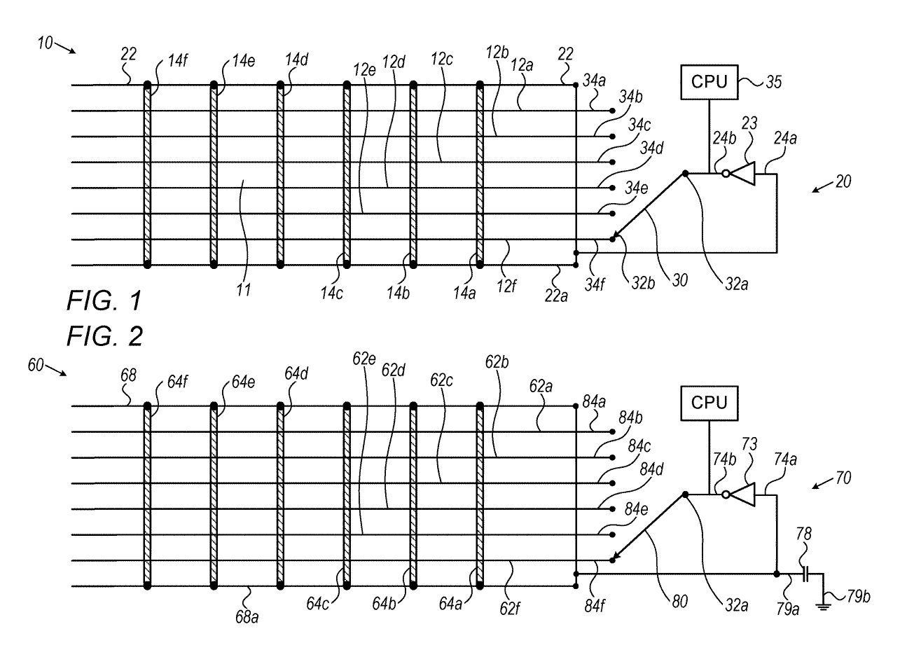

FIG. 1 shows a schematic illustration of a fret board 10 of a musical instrument (not shown) including a base board 11 having a plurality of conductive frets 14a through 14f transversely mounted thereon and a plurality of conductive strings 12a-12f extending along the length of the fretboard over the frets without touching them. The conductive strings 12a-12f and the conductive frets 14a-4f can be configured to allow transmitting through them a low voltage current, for example a current that is not sensed or affected by a user.

The conductive strings 14a-14f can vibrate freely, however controllably. The conductive strings 14a-14f can be made of a single material, such as steel, or can have a core of one material, over which is wound another materials, for example a core of plastic wound with a metal wire. In the latter case one or both materials are made of a conductive material.

It is appreciated that the number of strings and frets can vary in accordance with the requirements of the particular type of musical instrument on which the fretborad is mounted.

The fretboard 10 further includes a detecting system 20 configured for detecting the fret against which one of the strings 12a-12f is pressed, such that the chord or the note which is played can be detected.

The detecting system 20 includes at least one conductor 22 extending along the length of the fretboard 10 and being coupled to each of the frets 14a-14f. The conductor 22 can be integrated inside the base board 11 or can be mounted thereon.

The detecting system 20, includes a conductor 22, or two conductors 22, 22a, as illustrated in FIGS. 1 and 2 mounted on a side of the fretboard 10 such that each one of the frets 14a-14f is coupled at one end to a first conductor 22 and at the other end to the other conductor 22a. The advantage of having more than one conductor will be explained hereinafter.

The detecting system 20 further includes an inverter 23 (also known as a NOT logic) having an input terminal 24a and an output terminal 24b and is configured to output, at the output terminal 24b, a voltage representing the opposite logic-level than the voltage at the input terminal 24a. That is to say, if the input voltage corresponds to a logical 1 the output voltage of the inverter corresponds to a logical 0 and vice versa. The inverter can be any known inverter such as NC7SZ14 or the like or an inverting amplifier.

The input terminal 24a of the inverter 23 is coupled to the conductors 22, 22a, such that an electric signal therefrom can be logically inverted by the inverter 23. The output terminal 24b of the inverter 23 can be coupled to the strings 12a-12f such that the inverted signal can be transmitted thereto. Since it is desired to detect the fret against which the string is presses as well as to detect which of the strings 12a-12f is pressed, each of the strings 12a-2f can be individually and independently coupled to the inverter 23. This can be accomplished, for example, by having the strings 12a-12f coupled to the output terminal 24b of the inverter 23 by a demultiplexer 30 (also known as or demux). The demultiplexer 30 can include an input 32a configured to receive an input signal from the output terminal 24b of the inverter 23 and an output 32b configured to select one of many data-output-lines 34a-34f each of which is coupled to the terminal end of one of the strings 12a-12f.

The demultiplexer 30 can be configured to provide a cycle of instances, such that during each instance the output 32b thereof is coupled only to one of the data-output-lines 34a-34f. The output 32b can be configured to sequentially select one of the data-output-lines 34a-34f such that each one thereof sequentially receives a signal from the inverter 23. Since each one of the data-output-line 34a-34f is coupled to one of the conductive strings 12a-12f, the conductive strings 12a-12f are successively coupled, one at a time, to the output terminal 24b of the inverter 23 because of the operation of the demultiplexer 30, and an output signal can be transmitted therethrough. Alternatively the output terminal 24b of the inverter 23 can be coupled to strings 12a-12f through an analog switch such as the MAX459x, and the like.

The detecting system 20 further includes a frequency detector, configured to detect the frequency of the signal at the output terminal 24b, and a controller the purpose of which is discussed in detail herein below. The frequency detector and controller can be integrated in a CPU module 35 coupled to the output terminal 24b of the inverter 23. It will be appreciated that since the conductive strings 12a-12f, the conductor 22, and the inverter 23 form together an electric circuit the frequency detector can be coupled at any location thereof, i.e. at the output terminal 24b, the input terminal 24a or to the conductors 22, 22a.

The detection system further includes a power source (not shown) for generating an electric signal. The power source transmits electric signal through the conductive strings 12a-12f upon activation of the detection system.

As mentioned hereinabove, the frets 14a-14f are made of a conductive material, thus, pressing one of the conductive strings 12a-12f against one of the frets 14a-14f, facilitates closing a circuit formed by the respective conductive string, the conductors 22 and the inverter 23. For example, if conductive string 12f is pressed against fret 14e, the circuit is closed and an output signal is transmitted from the output terminal 24b of the inverter 23 through the demultiplexer 30, conductive string 12f, fret 14e and conductor 22 back to the input terminal 24a. If the voltage of the output signal corresponds to a logical 0, the voltage transmitted back through the conductive string 12f and the conductors 22 to the input terminal 24a corresponds to a logical 0 as well. As a response, the inverter 23 outputs an output signal having a voltage corresponding to a logical 1.

Further transmission of the output signal through the conductive string 12f, the fret 14e and the conductors 22 provides at the input terminal 24a a voltage corresponding to a logical 1, which is then inverted by the inverter 23 to a voltage at the output terminal corresponding to a logical 1. The transmission of the output signal between the output terminal 24b and the input terminal 24a, continues so long as the conductive string 12f is pressed against the fret 14e. Accordingly, the signal transmitted through the conductive string 12f alternates between logical 1 and logical 1.

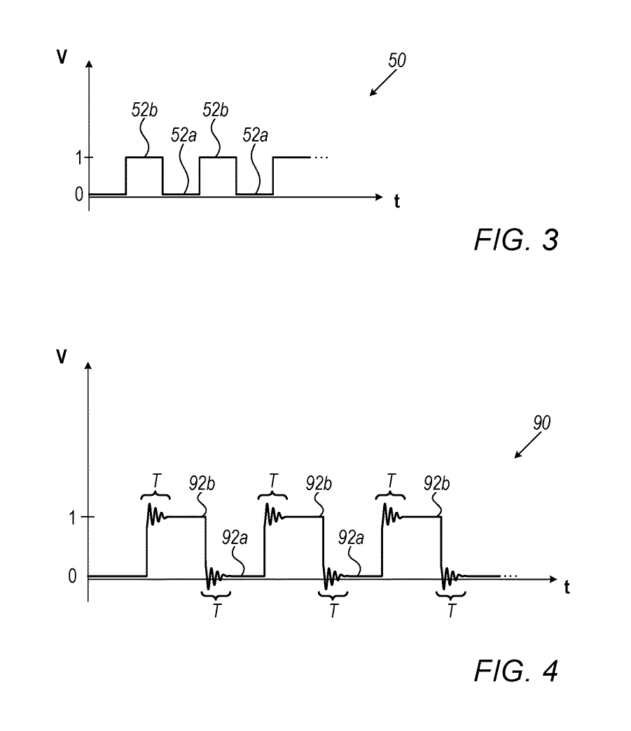

As shown in the graph illustrated in FIG. 3 the output signal, can be represented as a square wave, generally designated 50, alternating between a first phase 52a in which the voltage thereof corresponds to a logical 0, and a second phase 52b in which the voltage thereof corresponds to a logical 1.

Alternation between the first phase 52a and the second phase 52b occurs at a frequency depending on the time interval between an inversion of the inverter 23 and the following inversion thereof. Since the inversions successively occurs once the current completes a full cycle between the output terminal 24b and the input terminal 24a, the time interval between each inversion is determined by the time required for the output signal 50 to travel from the output terminal 24b back to the input terminal 24a of the inverter 23.

Accordingly, the frequency of the wave 50, i.e the amount of times the phases 52a and 52b change within a given time unit, varies depending on the distance between the output terminal 24a and the fret against which the conductive string is pressed. That is to say, if conductive string 12f is pressed against fret 14e, the distance through which the output signal travels is less than the traveling distance when the conductive string 12f is pressed against fret 14f. Thus, the frequency of the signal formed when the conductive string 12f is pressed against fret 14e is higher than that which is formed when the conductive string 12f is pressed against fret 14f.

It is appreciated that since the output signal is transmitted through the conductive string 12f and back through the conductors 22, the actual traveling distance of the signal between the output terminal 24b back to the input terminal 24a is approximately twice the distance between inverter 23 and the fret against which the string is pressed.

The CPU module 35 contains a frequency detector that measures the frequency of the wave generated by the alternating signal, and can further detect a change in the frequency resulting from the change in the traveling distance of the signal, which occurs upon changing the frets 14a-14f upon which the strings 12a-12f are pressed. The CPU module 35 is thus configured to determine upon which fret a conductive string is pressed in accordance with the detected frequency.

If, for example, the signal travels at the speed of light (c), and the distance between the inverter 23 and the fret against which the string is pressed is d, the frequency of the square wave generated by the alternating output signal can be represented as:

$$F = \frac{1}{{t}_{i} + {t}_{a}} ,$$

where t, is the internal time delay of the inverter 23 and where

$${t}_{0} = \frac{c}{2 d} .$$

Accordingly, the pressure of strings 12a-12f against one of the frets 14a-14f can be detected since each fret defines a specific distance from the inverter 23 (d). It is appreciated that detection of the fret against which the conductive string is pressed can be carried out for any one of strings 12a-12f. However, since each one of strings 12a-12f is disposed at a different distance from the conductor 22, the varying distances may affect the frequency of the signal transmitted therethrough. Thus, as mentioned previously, the fretboard 10 can include two conductors 22 and 22a, disposed along the outer longitudinal edges of the fretboard 10 and joined together at the input terminal 24a. The two conductors 22, 22a are disposed with respect to each one of the conductive strings 12a-12f such that the average of the distance thereof from each of the conductive strings 12a-12f is equal for all of the conductive strings. Thus, the two conductors 22, 22a provide a signal averaging, facilitating thereby an accurate detection of the frequency changes resulting from the varying distances between the inverter 23 and the fret against which the string is pressed.

According to a different example, a single conductor 22 can be used, the CPU however can be configured to detect the string which is being pressed and to calculate thereby the frequency, taking into consideration the distance between the string and the conductor 22. Detecting the string which is being pressed can be carried out for example by a pressure detector, or by receiving feedback from the demultiplexer 30. That is to say, the signal is transmitted back to the input terminal 24a only when the demultiplexer 30 is coupled to a conductive string which is currently being pressed. Thus, the demultiplexer 30 can provide the CPU with the data regarding the string which is being pressed, such that the fret against which is being pressed can be detected in accordance with the frequency of the signal taking into consideration the distance between string and the conductor 22.

It is appreciated that the inverter 23 the demultiplexer 30, the CPU or any other electronic components can be disposed at any location on a string instrument. For example these electronic components can be integrated in a module which can be coupled to a string instruments, for example via a dedicated interface on the instrument. This way, a module can be coupled to a string instrument when the user wishes to receive indication regarding the notes and chords being played.

FIG. 2 is a block diagram of a fretboard 60 and detecting system 70 in accordance with another example of the invention. The fretboard 60 is substantially the same as the fretboard 10 of FIG. 1 and includes a plurality of conductive strings 62a-62f and a plurality of frets 64a-64f coupled to one or more conductors 68, 68a. Similarly, the detecting system 70 is substantially the same as the detecting system 20 of FIG. 1, and includes an inverter 73 having an input terminal 74a, an output terminal 74b and a demultiplexer 80 configured for selecting one of many data-output-lines 84a-84f each of which being coupled to one of the conductive strings 62a through 62f.

According to the present example, the detecting system 70 further includes a capacitor 78 coupled to an input terminal 74a of the inverter 73. The capacitor 78 is configured such that a signal transmitted through the conductors 68, 68a, charge the capacitor which in return charges back the conductors, thus forming a resonance therebetween. The resonance is in the form of an electric oscillation created by the interaction between the capacitor 78, the conductor 68 and the conductive string which is being pressed against one of the frets 64a-64f. Due to the resistance of the conductors 68,68a and the conductive string 62a-62f. The electric oscillation is decayed following which the signal reaches the input terminal 74a of the inverter 73. When the signal enters the inverter 73 the signal is inverted. For example, if the signal at the input terminal 74a is at a voltage corresponding to a logical 1, the inverter 73 inverts to the signal to the opposite logic-level thereof, i.e. 0, as explained hereinabove with respect to FIGS. 1 and 3.

Similar oscillation occurs when the voltage corresponding to a logical 0 is transmitted through the conductive string and the conductors 68. The electric oscillation is decayed following which the logical 0 signal reaches the input terminal 74a of the inverter 73 where it is inverted back to logical 1.

Thus, as shown in the graph of FIG. 4, the signal can be represented as a square wave, generally designated 90, alternating between a first phase 92a in which the voltage thereof corresponds to a logical 0, and a second phase 92b in which the voltage thereof corresponds to a logical 1. Each one of the first and second phases 92a and 92b includes a decay time, which can be represented as T, which increases the wavelength of the signal at 2T, due to the fact that the oscillation occurs twice in each wavelength, i.e. one time for the logical 0 phase and a second time for the logical 1 phase. This results in a signal having larger wavelength, i.e. having a lower frequency, such that detecting minor frequency changes is facilitated.

It is appreciated that according to other examples the detecting system can include other electronic component for delaying the signal thereby increasing the wavelength, for example a serial inductor or delay line.

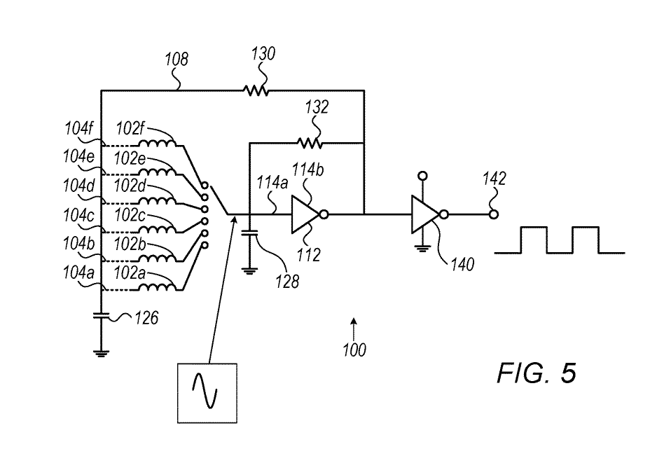

FIG. 5 shows an electric circuit 100 according to another example of the presently disclosed subject matter. The circuit 100 according to this example, can be configured to generate a substantially sine electric signal, as opposed to a square electric signal. For example, the circuit can be an electronic oscillator such as a colpitts oscillator. That is to say, the circuit 100 can include plurality of conductive strings 102a-102f and a plurality of frets 104a-104f coupled to at least one conductor 108. The circuit 100 can further include an inverter 112 having an input terminal 114a, an output terminal 114b and a demultiplexer 120 configured for selecting one of the conductive strings 102a through 102f.

According to the present example, the circuit 100 further includes a capacitor 128 coupled to an input terminal 114a of the inverter 112, and an additional capacitor 126 coupled to the conductor 108. The additional capacitor 126 can be configured such that a signal transmitted through the conductors 108, charges the capacitor 126 which in return charges back the conductors, thus forming a resonance therebetween.

The resistors 130 and 132 together with capacitors 128 and 126 are configure to form a sine signal when one of the strings is engaged with one of the frets 104a-104f. Forming the sine signal precludes noises and interferences associated with high frequencies included in the square signal.

The circuit 100 can further include an additional transistor 140 coupling the output terminal 114b of the invertor 112 and a frequency detector 142, and is configured to form a substantially square signal at the frequency detector 142, facilitating thereby the detection of the frequency.

Those skilled in the art to which the presently disclosed subject matter pertains will readily appreciate that numerous changes, variations, and modifications can be made without departing from the scope of the invention, mutatis mutandis.

1. A detection system for detecting a musical note played on a string instrument having a fret board provided with a plurality of conductive frets and at least one conductive string extending along thereof, the detection system comprising:
at least one conductor coupled to each of said frets;
an inverter having a first terminal coupled to said conductor and a second terminal coupled to the conductive string, said inverter being configured to logically invert a signal transmitted therethrough, such that when the conductive string is pressed against one of said frets allowing thereby for a signal to be transmitted therethrough, said signal is sequentially inverted between two logical states at a frequency being dependent on the distance between said inverter and said fret;
a frequency detector configured to measure said frequency; and,
a controller configured for determining the location of said fret along the fretboard in accordance with said frequency, and to thereby detect the musical note.

2. The detection system according to claim 1, wherein said inverter is configured to select one of many data-output-lines each of which being configured to be coupled to one conductive strings of a musical instrument having a plurality of conductive strings extending long the fretboard thereof.

3. The detection system according to claim 2, further comprising a demultiplexer having an input configured to receive an input signal from said inverter and an output configured for selecting one of many data-output-lines each of which being coupled to one of said plurality of conductive strings.

4. The detection system according to claim 2, wherein said first terminal of said inverter is an input terminal and said second terminal is an output terminal.

5. The detection system according to claim 4, wherein said inverter is configured to invert an input voltage corresponding to a logical 1 to an output voltage of corresponding to a logical 0.

6. The detection system according to claim 2, further comprising a controller being configured to detect which one of said plurality of conductive strings is being pressed against one of the plurality of frets.

7. The detection system according to claim 1, further comprising a capacitor coupled to said inverter and being configured to form a signal resonance in said signal thereby delaying the signal for delaying the signal thereby increasing the wavelength thereof.

8. The detection system according to any one of claims 2, comprising a power source for generating a signal through the conductive string.

9. A detection system according to claim 2, further comprising a demultiplexer having an input configured for receiving an input signal from said inverter and an output configured for selecting one of many data-output-lines each of which being coupled to one of said plurality of conductive strings.

10. The detection system according to claim 2, wherein said inverter is configured to select one of many data-output-lines each of which being configured to be coupled to one conductive strings of a musical instrument having a plurality of conductive strings extending long the fretboard thereof.

11. The detection system according to claim 10, further comprising a demultiplexer having an input configured to receive an input signal from said inverter and an output configured to select one of many data-output-lines each of which being coupled to one of said plurality of conductive strings.

12. The detection system according to claim 2, further comprising a controller configured to detect which one of said plurality of conductive strings is being pressed against one of the plurality of frets.

13. The detection system according to claim 26, further comprising an electronic component coupled to said inverter configured to delay the signal thereby increasing the wavelength thereof.

14. The detection system according to claim 29 wherein said electronic component is a capacitor configured to form a signal resonance in said signal thereby delaying the signal.

15. The detection system according to claim 1 wherein said detecting system further comprises electronic components configured to form an oscillating electronic signal having a substantially sine shape.

16. A method for detecting a musical note played on a string instrument having a fretboard provided with a plurality of conductive frets each of which being coupled to a conductor, and at least one conductive string extending along the length of the fretboard, the method comprising:
generating an electric signal through the conductive string, that can be transmitted through one of the frets when the conductive string is pressed against the fret;
logically inverting the signal by an inverter having a first terminal coupled to the conductor and a second terminal coupled to the conductive string, such that when the conductive string is pressed against one of said frets allowing thereby said signal to be transmitted through the conductor, said signal sequentially inverted between two logical states at a frequency dependent on the distance between said inverter and said fret;
detecting said frequency by a frequency detector;
calculating the location of the fret along the fretboard in accordance with said frequency; and,
determining the musical note played on the instrument in accordance with said location.

17. A fretboard of a string instrument in combination with a detecting system, said fretboard having a plurality of conductive frets disposed at various locations along its length and at least one conductive string extending over and spaced apart from the frets along the length of the fretboard; said detecting system comprising:
a conductor disposed along the length of the fretboard coupled to each of said frets;
an inverter having a first terminal coupled to said conductor and a second terminal coupled to said at least one conductive string and being configured to logically invert a signal transmitted therethrough such that when said at least one conductive string is pressed against one of said frets allowing thereby a signal to be transmitted therethrough, said signal is sequentially inverted between two logical states at a frequency dependent on the distance between said inverter and said fret;
a frequency detector for measuring said frequency; and,
a controller for determining the location of said fret along the fretboard in accordance with said frequency.

18. The combination of claim 17, wherein said fretboard comprises a plurality of conductive strings.

19. The combination according to claim 18 comprising two conductors disposed with respect to each one of said plurality of conductive strings such that the average of the distance thereof from each of said plurality of conductive strings is equal for all of said plurality of conductive strings.

20. The combination according to claim 17 wherein said conductive string is configured to vibrate producing thereby a musical sound.
